(19) United States
(12) Patent Application Publication
(10) Pub. No.: US 2008/0120668 A1
(43) Pub. Date: May 22, 2008

(54) Integrated IPTV display set and methods

(76) Inventor: Frank Chuen-Foo Yau, Redwood City, CA (US)

Correspondence Address: FRANK YAU, 258 NICE COURT, REDWOOD CITY, CA, 94065, US

(21) Appl. No.: 11/986,004

(22) Filed: Nov. 19, 2007

Related U.S. Application Data
(60) Provisional application No. 60/860,037, filed on Nov. 18, 2006.

(51) Int. Cl. H04N 7/173

(52) U.S. Cl. 725/110

(57) ABSTRACT

An integrated IPTV display set, without the use of set-top-box or separate PC, is an interactive electronic display set to feature playback of IPTV programming using graphical user interface and network access to the internet or intranet via wired or wireless broadband connectivity to enable lean back TV viewing experience using a remote control or keyboard for programming selections with all of the lean-forward functions as versatile web browsing point and click navigation featuring customized display and advertising methods.

### RELATED APPLICATIONS

This application claims the priority of U.S. provisional patent application Ser. No. 60/860,037 filed on Nov. 18, 2006.

### FIELD OF THE INVENTION

The present invention relates to electronic display set of network delivered video playback, and more particularly to integrated IPTV (Internet Protocol Television) display set and methods without set-top-box as in prior art.

### BACKGROUND OF THE INVENTION

More and more traditional and new generation TV programming and video content are being featured over the internet by streaming or delivered on-demand. Viewers would prefer to enjoy the same experience as watching broadcast or cable television without a personal computer (PC) and perhaps over an integrated IPTV display set without set-top-box.

IPTV has enabled global access to TV and video content by individuals for information and entertainment in real-time casting or on-demand anytime and anywhere especially at home for enjoyment much like the traditional TV sets have provided local or national viewing by the general public in masses. IPTV will become the choice medium of TV programming and video content delivery in our ever evolving digital world.

Prior art in IPTV viewing has been using set-top box to access the internet for video streaming and delivery to feed a television set for the television viewing experience instead of a PC.

The prior art in IPTV lacks the TV viewing experience over PC or capability to take full advantages of functions and options that IPTV and digital media intended over TV set-top-box.

The integrated IPTV embedded display set, in the present invention, not only can provide a better TV viewing experience but easier for viewers to access and select IPTV programming and video content available over the internet and able to combine enjoyment with much more digital media options with less cumbersome external hardware and connections required.

The present invention minimizes hardware and interface with set-top-box to a television set having the aforementioned and other advantages.

Other uses for such an integrated IPTV display set will become apparent to those skilled in the art once they have knowledge of the present disclosure.

### SUMMARY OF THE INVENTION

In accordance with the present invention, the integrated IPTV display set provide dedicated IPTV hardware and methods for ease of internet TV and video access and viewing without separate PC or set-top-box to provide a much better TV like viewing experience using remote control functions.

Additionally, the integrated IPTV display set can be used as a fixed set for larger display sizes or portable for smaller suitable display sizes, powered with battery or fuel cell, with wired or wireless connectivity to the internet or local network.

Purity of integrated IPTV display sets can be interconnected in a local network for accessing the internet or local digital content sources.

The present invention also illustrates wireless keyboard and features that are used with the integrated IPTV display set to enhance interactivity.

Display screen graphical layout control options and methods of the integrated IPTV display set are described and illustrated in the present invention.

Accordingly, the present invention provides integrated IPTV display with vast varieties of optional multimedia features and functions that can be included by interface with the core hardware and software of the integrated IPTV display set for enhanced viewing experience and enjoyment.

Other objects, advantages and novel features of the present invention will become apparent from the following detailed description of the invention when considered in the conjunction with accompanying drawings.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1 is a pictorial representation of an integrated IPTV display set with remote control according to the present invention.

FIG. 2 is a pictorial representation of a portable integrated IPTV display set according to the present invention.

FIG. 3 is a pictorial representation of integrated IPTV display sets in a local network according to the present invention.

FIG. 4 is a pictorial representation of a wireless keyboard for use with the integrated IPTV display set according to the present invention.

FIG. 5 is a pictorial representation of display screen graphical layout control options and methods of the integrated IPTV display set according to the present invention.

FIG. 6 is a pictorial representation of optional features and interfaces for the integrated IPTV display set according to the present invention.

### DETAILED DESCRIPTION OF THE INVENTION

Referring now descriptively to the drawings, the attached figures illustrate the methods of Integrated IPTV display set:

The following description of the preferred embodiment of the invention is not intended to limit the scope of the invention but rather to enable any person skilled in the art to make and use this invention.

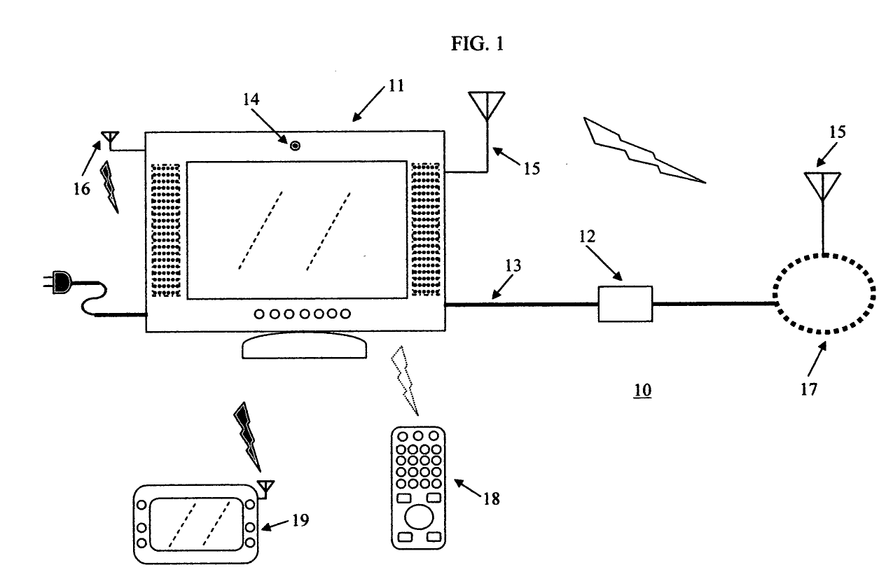

As shown in FIG. 1, the present invention 10 is an integrated IPTV display set 11 with remote control 18 to enable direct playback of IPTV video and features without set-top-box or separate PC required to access TV and video content over the internet using a remote control for select channels, content, and functions in real-time internet-casting, streaming, or on-demand with customized GUI layout on selections of functions and available IPTV channels or URLs on free or chargeable content.

The integrated IPTV display set 11 is interactive electronic display set to feature dedicated linkages to IPTV programming via graphical user interface in enabling lean back TV viewing experience using a remote control for programming selections with all of the lean-forward functions such as versatile web browsing point and click navigation.

The integrated IPTV display set 11 provides traditional TV viewing experience with a single package, compact in thickness and minimized peripherals and connections to emulate a traditional TV set with remote control for channel surfing to enable home bound comfort.

The integrated IPTV display set 11 is designed for plug and play set-up and auto network configuration for network access to the internet or intranet via wired or wireless broadband connectivity either locally or remotely from initial preset parameters or automatic internet connectivity to product support server to register for periodically update and administrative contact.

The broadband connectivity is established via high-speed Ethernet 13 cabling to the network router or modem 12 connected to the internet 17 or local network digital media source. Alternatively, the connectivity can be via power over Ethernet, gigabit or fiber optic networking. The network router or modem 12 can also be built-in to the integrated IPTV display set 11.

Suitable wireless network interface 15, such as but not limited to, WiMax, WiFi, or UWB wireless standard can be used for wireless broadband access to wireless connectivity 15 to the internet 17 or local network digital media source.

The integrated IPTV display set 11 is built with universal electrical power requirements to meet common voltage worldwide such as 110 VAC at 60 Hz or 220V at 50 Hz. The main electronic circuitry is an embedded motherboard contains circuitry to enable digital video to be displayed with small to large LCD display panel, plasma display, OLED display, or employing any advance suitable digital display technology, in any size display formats including standard and widescreen, and resolutions including HDTV quality and HD Plasma display. Embedded hardware is designed to drive different sizes of the integrated electronic display packaged in a single integrated housing equivalent to a flat LCD TV set. Video player can be hardware or software decode and the embedded hardware be capable to work with multiple digital video formats and video player application software for the best digital video playback requirements on various suitable digital video and audio formats, resolutions, frame rates, and data rates; the video player will also provide automatic frame buffering for smooth playback when only low bandwidth connectivity is available. The embedded hardware would be capable to operate with open architecture for application software updates and upgrades for streaming protocol and QoS service. Software update can be accomplished remotely. Operating system software can be Window, Linux, RTOS, or any suitable operating systems, working with suitable drivers and other application software including, but not limited to, suitable runtime environment platform for desktop graphical rendering, web browser, multi-language and subtitle media decode, and DRM (Digital Right Management) content decode for content copyright protection. The embedded hardware includes also microprocessor, optional content storage with solid state or disk drive storage, optional graphics accelerator hardware, bootable flash, SDRAM, USB interface, wired and wireless network interfaces for high-speed Ethernet (100BaseT), gigabit Ethernet or fiber optic network interface for suitable network protocol and internet protocol such as, but not limited to, IPv4 or IPv6.

Integrated IPTV display set 11 is built-in with speakers for stereo or mono audio outputs_and optional interface for wireless stereo speakers or stereo headphones and connection interface for additional stereo speakers for surround sound, and stereo headset plug-in built-in in the front of the set along with other adjustment buttons.

Wireless or IR remote control 18 provides, but not limited to, functions in Record, Delete, Mute, Play, Bookmark, Program Guide, Info, Channel Up, Channel Down, Volume, TV Mode option, IPTV Mode, Trick Play, PIP, Broadcast or Cable TV mode from external digital or analog video feed such as satellite TV. Trick play features are pause, fast forward, rewind, stop, and play. Additional optional feature is to enable remote steering of the IPTV display set 11 viewing angle from controlling tilt and azimuth in the mechanical base of the Integrated IPTV display set 11. Additionally, color of the Integrated IPTV display set 11 enclosure or case can be changed to different colors and effects depending on the moods or occasions of the viewers by selecting from the remote control 18 or auto setting. A remote control 18 locator function can also be featured as an option for locating the device when not able to be located in the proximity by pressing a respective function key on IPTV display set 11 to activate an alert sound from the device.

A built-in camera 14 on the integrated IPTV display set can be control remotely to steer or tilt for scanning the surrounding for security and situation awareness where the captured or recorded video from the camera could be accessed remotely via the internet or local network for storage or playback.

Wireless remote control with LCD, or any suitable digital display technology, touchscreen 19 features replicated GUI image as shown on the integrated IPTV display set screen or online IPTV program guide for navigation and selections in additional to functions as listed above for remote control 18. It can also feature optional built-in speaker, headset plug-in, and microphone. The wireless link with the integrated IPTV display set 11 is via any suitable wireless standard interface 16, but not limited to such as WiFi, Bluetooth, Wireless USB, UWB, or IR.

The integrated IPTV digital content can be delivered on-demand or pre-programmed via multicast or unicast streaming or download from video on-demand content sites on-demand or preprogrammed from the internet 17, local digital media source or hybrid from internet 17 and local digital media sources.

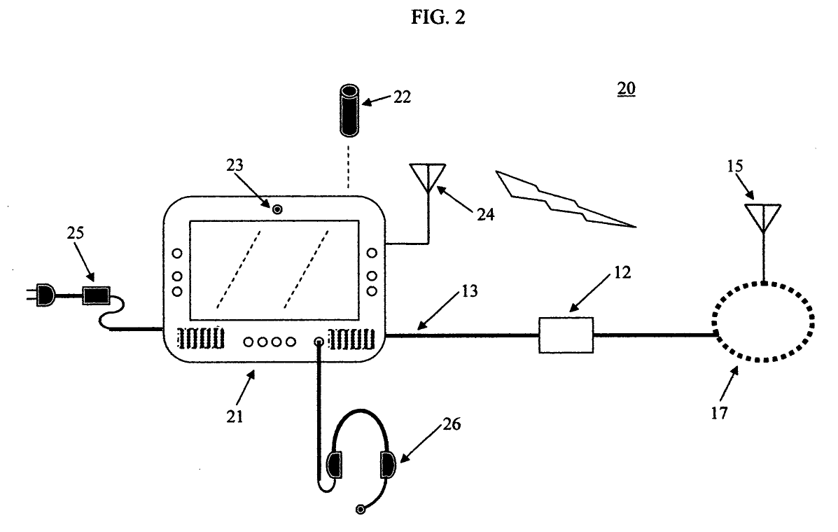

As shown in FIG. 2, another embodiment in the present invention 20 is an integrated IPTV display set 21 with smaller LCD display panel using LED backlight option for lower power consumption, or OLED, or any suitable digital display technology, with touchscreen or remote control that allow both fixed and portable usage, can be powered by universal electrical power supply 25 to meet common voltage requirements worldwide such as 110 VAC at 60 Hz or 220V at 50 Hz or battery or micro fuel cell 22 for portability and mobility with suitable wireless interface 24 such as, but not limited to, WiMax, WiFi, or UWB wireless standard that can be used for wireless broadband access to wireless connectivity 15 to the internet 17 or local network digital media source or broadband connectivity via high-speed or gigabit Ethernet 13 via network router or modem 12. An optional built-in camera 23 is available to capture photos or video and connection interface with stereo headset with microphone 26 is also provided to facilitate personal communications and enjoyment. Other possible features and functions are as listed in FIG. 1.

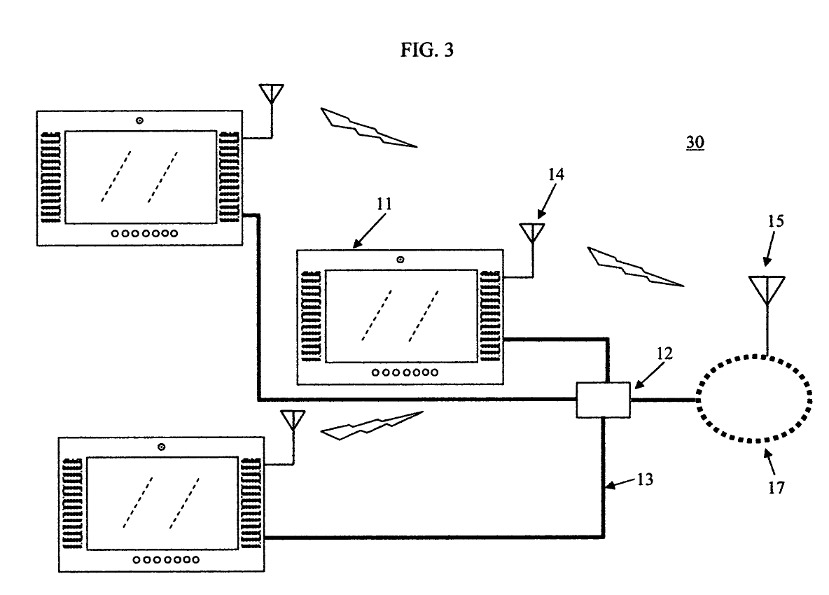

FIG. 3 is a pictorial representation of purity of integrated IPTV display sets 11 interconnected in a local network 30 according to the present invention. Purity of the integrated IPTV display sets 11 can be connected and configured in a local area network broadband connectivity via high-speed Ethernet 13 cabling to a network router or modem 12 with DHCP function to the internet 17 or local digital media source for accessing digital media content. Alternatively, the connectivity can be via gigabit or fiber optic networking.

Suitable wireless network interface 14, such as but not limited to, WiMax, WiFi, or UWB wireless standard can be used for wireless broadband access to wireless connectivity 15 to the internet 17 or local network digital media source in clustered network manner.

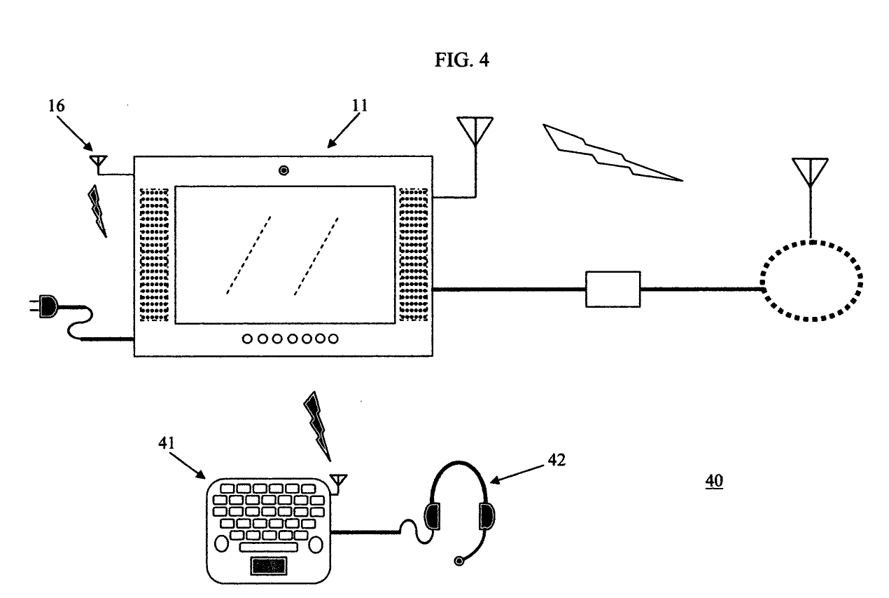

As shown in FIG. 4, another embodiment in the present invention 40 is an integrated IPTV display set 11 via any suitable wireless standard interface 16, but not limited to, such as WiFi, Bluetooth, Wireless USB, UWB, or IR with wireless keyboard 41, in optional thumb control layout, with mouse pad, game control buttons and switches. The wireless keyboard 41 is powered by replaceable or rechargeable battery also feature wireless digital audio streaming from the integrated IPTV set 11 to the remote keyboard with built-in noise canceling circuit with audio headset plug-in for stereo audio headset and audio microphone 42 or self built-in noise canceling stereo audio headsets.

Wireless keyboard 41 features also joystick functions, buttons, type keys pad, touch pad, for interactive gaming, functional selections, and commands as well as optional combined remote control functions in Record, Delete, Mute, Play, Bookmark, Channel Up, Channel Down, Volume, TV Mode option, IPTV Mode, Trick Play, PIP, Broadcast or Cable TV mode from external digital or analog video feed such as satellite TV. Trick play features are pause, fast forward, rewind, stop, and play. Optional bio-payment reader can be built-in on the remote keyboard 41 for payment transactions

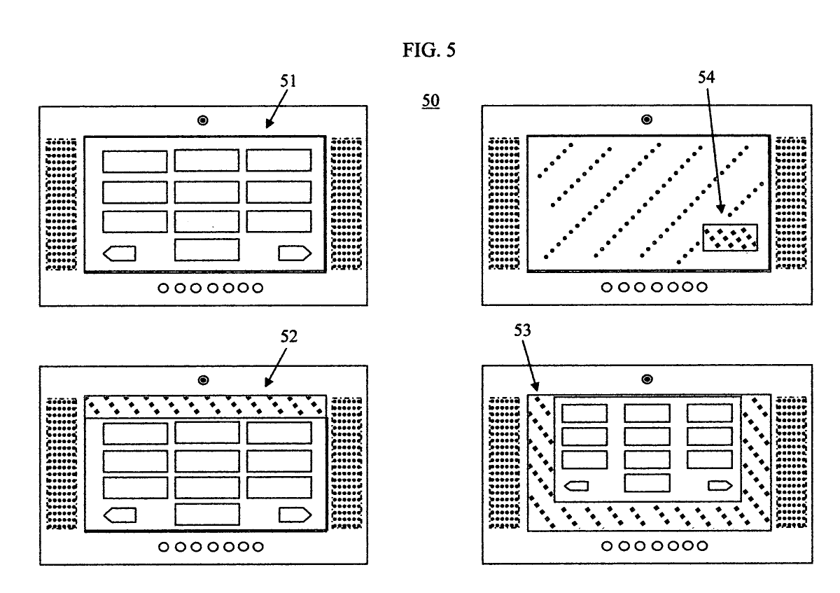

As shown in FIG. 5, another embodiment in the present invention 50 is an integrated IPTV display set 11 features web browser with graphical overlay or widget multimedia application 51 with preset or preprogrammed web address or URL represented by graphical user interface (GUI) for relevant IPTV, video, audio, webcasting, internet radio or video on-demand websites. GUI selections for video, IPTV, music playback, download, magazine, web pages, email option are prioritized or sorted by preferences, types, origin, culture, genre, country etc . . .

The Home page selections for example could feature:
1) IPTV and optional broadcast or cable TV from TV tuner.
2) Video On-Demand with cache video, on-line video on-demand (VOD), and online movie rental.
3) Music audio on-demand, cache music audio, internet access music stores or internet radio.
4) Interactive games in cache, online download or multi-player games.
5) Reading with digital publication download on book and magazine with bookmark capability. Digital publication could also contain video playback as well as video channel selections.
6) Shopping feature preferred shopping portal or URLs and categories by products and services in internet mall (iMall).
7) Web browsing features partner search engine site and preferred web portals.
8) Internet or widget browsing provides internet access.
9) Email and VoIP for personal communications.

Periodic update can be scheduled automatically on IPTV user interface selections.

IPTV channels and program listing on GUI presented can be customized and emphasized based on geographic location and culture preference of the viewer. Interface GUI can be remotely updated by the central management resources; user and feedback data can be collected and retrieved by the central management resources. The selection data base and GUI icons can also be automatically generated from online EPG (Electronic Program Guide) which can be provided or generated by third party sources or delivered or selected from the central management sources based on viewer's preference. All selections, interaction, and usages may be track-able and reportable.

Fringe areas on the display screen 52 or 53 for advertisement or electronic messages are optional to provide advertisement or sponsor messages. Fringe Advertisement placement would either be based on content relevance, partner relationship with the sponsor or advertiser, personal preference of the viewer or driven by paid sponsors for placement at fixed or bid price by masses across all viewers globally, regionally, nationally, or individually for specific IPTV display set based on viewer's data on viewing preferences, usages, personal preferences, and culture background. Traditional and non-traditional advertisement would be possible as well as interactive advertisement with surveys and direct response marketing would be suitable.

Content and channel selection layout and placement on IPTV channel URL, VOD, broadcast or cable TV programs, music, games, reading content, shopping portal, web portal can be placed in more visible and accessible either be based on content popularity, partner relationship with the sponsor, personal preference of the viewer or driven by paid sponsors for placement at fixed or bid price by masses across all viewers globally, regionally, nationally, or individually for specific IPTV display set based on viewer's data on viewing preferences, usages, personal preferences, and culture background. Additionally to placement or the layout on the selection screen page, channel or feature icons can contain logo or sponsor messages.

Internet browsing option can enable relevant or general advertising messages on the fringe of the display screen 52 or 53.

Optional PIP (picture-in-picture) pop-up alert 54 is activated on the screen when any VoIP call, VoIP voicemail, video-mail, email, or voice-email is received.

Smaller play screen for program information and viewing for video and audio programming is featured during selection or browsing and can be switched to full screen playing for video playback on free programming or payment to be made on-line on pay-per-view (PPV), chargeable, or subscription programming before full screen playback is available.

Payment methods can be onscreen entry, electronic credit card reader, or bio-payment reader built-in on remote control 18 or 19 or wireless keyboard 41 or the portable version of the integrated IPTV display set 21.

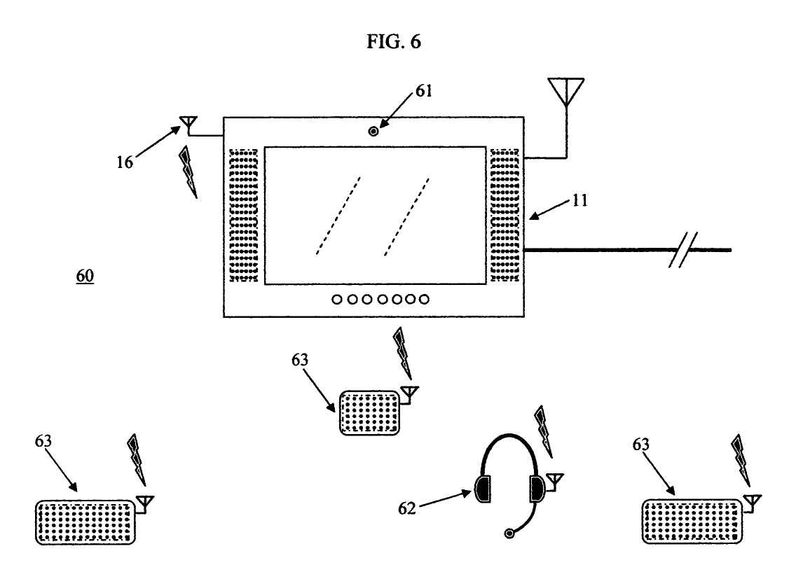

As shown in FIG. 6, another embodiment in the present invention 60 is an integrated IPTV display set 11 with integrated multimedia options that enhance the interactive viewing and enjoyment experience with added functions and built-in features such as digital TV Tuner, digital cable TV tuner, external digital or analog video feed such as satellite TV, broadcast radio tuner, DVD, CD, CDR/W, Blue-ray disk player, surround sound systems, and or built-in timer and alarm functions.

PC card interface is used for optional TV tuner for ease of replacement and adaptation to various standards as well as other possible add-ons. Provisions are possible for cable TV conditional access interface and middleware for payable video content access such as digital cable TV programming over the internet.

Integrated IPTV display set 11 can be provided with optional built-in storage with harddisk or solid state drive for digital recording and playback or re-stream to other peer IPTV sets as a media server or source.

Integrated IPTV display set 11 can be provided with optional built-in digital publication reader for portable reading or electronic photo display using files stored in removable solid-state memory disk such as compact-flash card or download via wired network, optical link, or any suitable wireless links such as, but not limited to, Bluetooth, wireless USB, ultra-wideband (UWB), or WiFi. When the integrated IPTV display set is not in used in video or TV viewing mode, it could play static photo as a electronic photo frame.

The integrated IPTV display set 11 can be provisioned with a built-in camera 61 for video and photos as well as telephone and conferencing over VoIP calls, VoIP voicemail, video-mail, or voice-email with built-in microphone or connected with wired or wireless headset with microphone 62 or via the wireless keyboard 41. Voice activated control commands for specific languages are also possible. Additionally, wireless audio streaming over surround sound speakers 63 or noise canceling stereo headsets 62 can use Bluetooth, IR, WiFi, wireless USB or UWB built-in interface 16.

Other optional provisions for external connections are wireless USB, UWB, RCA video inputs, stereo audio input, earphone and microphone jacks, USB, external antenna, PC card or PCI slots, HDMI, DVI, S-video, composite video, IEEE 1394 Firewire, BNC coaxial cable, SDI, HD-SDI, CF, and SD.

The described methods in the present invention shall meet applicable regulations, certifications, and required markings for the purposes and environment that they are intended to operate.

Any other embodiments of the present invention that result from any changes in application or method of use or operation, method of manufacture, shape, size, or material which are not specified within the detailed written description or illustrations contained herein yet are considered apparent or obvious in the art that are within the scope of the present invention.

I claim:

1. An integrated IPTV display set, without the use of set-top-box or separate PC, is an interactive electronic display set to feature linkages to IPTV programming using graphical user interface and network access to the internet or intranet via wired or wireless broadband connectivity to enable direct playback of IPTV video content by using a remote control or keyboard for selecting channels, content, and functions comprising: main electronic circuitry to enable digital video rendering over suitable digital display technology in any display formats, wireless remote control interface, networking interface, local and removable content storage, built-in camera, and external interfaces.

2. The integrated IPTV display set of claim 1, wherein the wireless remote control comprise suitable digital display technology with touchscreen to replicate the GUI image as shown on the integrated IPTV display set screen or online IPTV program guide for navigation with optional built-in speaker, headset plug-in, and microphone.

3. The integrated IPTV display set of claim 1, wherein the broadband connectivity is established via high-speed Ethernet cabling to the network connected to the internet or local network digital media source; alternatively, the connectivity can be via power over Ethernet, gigabit or fiber optic networking.

4. The integrated IPTV display set of claim 1, wherein suitable wireless network interface is such as, but not limited to, WiMax, WiFi, or UWB wireless standard can be used for wireless broadband access to wireless connectivity to the internet or local network digital media source.

5. The integrated IPTV display set of claim 1, wherein remote steering by remote control of the IPTV display set can enable the adjustment of viewing angle from a viewer by controlling tilt and azimuth in the mechanical base of the Integrated IPTV display set.

6. The integrated IPTV display set of claim 1, wherein the color of the Integrated IPTV display set enclosure can be changed to different colors and effects depending on the moods or occasions of the viewers by selecting from the remote control or auto setting.

7. The integrated IPTV display set of claim 1, wherein a remote control locator function can be featured in locating the device when in the proximity by pressing a respective function key on IPTV display set to activate an alert sound from the remote control device.

8. The integrated IPTV display set of claim 1, wherein a built-in camera on the integrated IPTV display set can be control remotely to steer or tilt for scanning the surrounding for security and situation awareness where the captured or recorded video from the camera could be accessed remotely via the internet or local network for storage or playback.

9. The integrated IPTV display set of claim 1, wherein the LCD display panel using LED backlight option for lower power consumption, OLED, or any suitable digital display technology, employing touchscreen or remote control enable fixed or portable applications.

10. The integrated IPTV display set of claim 1, wherein purity of integrated IPTV display sets can be interconnected in a local network with broadband connectivity via high-speed Ethernet, gigabit or fiber optic networking to the internet or local digital media source.

11. The integrated IPTV display set of claim 1, wherein wireless keyboard features wireless digital audio streaming from the integrated IPTV set to the remote keyboard with built-in noise canceling circuit with audio headset plug-in for stereo audio headset and audio microphone or self built-in noise canceling stereo audio headsets.

12. The integrated IPTV display set of claim 1, wherein bio-payment reader can be built-in on the remote keyboard or remote control for payment transactions.

13. The integrated IPTV display set of claim 1, wherein the fringe areas on the display screen for advertisement or electronic messages are to provide advertisement or sponsor messages where the placement would either be based on content relevance, partner relationship with the sponsor or advertiser, personal preference of the viewer or driven by paid sponsors for placement at fixed or bid price for featuring across all viewers globally, regionally, nationally, or individually for specific IPTV display set based on viewer's data on viewing preferences, usages, personal preferences, and culture background.

14. The integrated IPTV display set of claim 1, wherein content and channel selection layout and placement on IPTV channel URL, VOD, broadcast or cable TV programs, music, games, reading content, shopping portal, web portal can be placed in more visible and accessible either be based on content popularity, partner relationship with the sponsor, personal preference of the viewer or driven by paid sponsors for placement at fixed or bid price to feature across all viewers globally, regionally, nationally, or individually for specific IPTV display set based on viewer's data on viewing preferences, usages, personal preferences, and culture background.

15. The integrated IPTV display set of claim 1, wherein small play screen for program information and viewing for video and audio programming is featured during selection or browsing and can be switched to full screen playing for video playback on free programming or payment to be made on-line on pay-per-view (PPV), chargeable, or subscription programming before full screen playback is available.

16. The integrated IPTV display set of claim 1, wherein a built-in digital publication reader for portable reading or electronic photo display using files stored in removable solid-state memory disk such as compact-flash card or download via wired network, optical link, or any suitable wireless links such as, but not limited to, Bluetooth, wireless USB, ultra-wideband (UWB), or WiFi.

17. The integrated IPTV display set of claim 1, wherein the integrated IPTV display set can play static photo as a electronic photo frame while not in used in video or TV viewing mode.

18. The integrated IPTV display set of claim 1, wherein a built-in camera denables video and photos as well as telephone and conferencing over VoIP calls, VoIP voicemail, video-mail, or voice-email with built-in microphone or connected with wired or wireless headset with microphone or via the wireless keyboard.

19. The integrated IPTV display set of claim 1, wherein built-in storage with harddisk or solid state drive for digital recording and playback or re-stream to other peer IPTV sets as a media server or source.

20. The integrated IPTV display set of claim 1, wherein external connections are wireless USB, UWB, RCA video inputs, stereo audio input, earphone and microphone jacks, USB, external antenna, PC card or PCI slots, HDMI, DVI, S-video, composite video, IEEE 1394 Firewire, BNC coaxial cable, SDI, HD-SDI, CF, and SD.
